(19) United States
(12) Patent Application Publication
(10) Pub. No.: US 2002/0032693 A1
(43) Pub. Date: Mar. 14, 2002

(54) Method and system of establishing electronic documents for storing, retrieving, categorizing and quickly linking via a network

(76) Inventors: Jen-Diann Chiou, Hsinying (TW); Hsiao-Chun Tang, Taipei (TW)

Correspondence Address: BACON & THOMAS, PLLC, 625 Slaters Lane-4th Floor, Alexandria, VA, 22314-1176, US

(21) Appl. No.: 09/761,705

(22) Filed: Jan. 18, 2001

(30) Foreign Application Priority Data
Sep. 13, 2000 (TW) 89118767

(51) Int. Cl. G06F 17/21

(52) U.S. Cl. 707/500; 707/513

(57) ABSTRACT

A retrieval system is disclosed, which has: a database for storing associated data of all electronic documents; a server connected to a network, the server includes: an uploaded document receiving means for receiving an uploaded document that includes a plurality of predetermined definition items, and individually storing the document according to the predetermined definition items in the database; a query receiving means for receiving a query from a user; a selecting means for extracting a conforming document and associated data from all the documents stored in the database by executing a predetermined algorithm to find a conforming document and other associated data; and a linking format generating means for transforming the conforming document and associated data into a predetermined format to automatically generate hyperlinks for each predetermined definition item.

### BACKGROUND OF THE INVENTION

1. Field of the Invention

The present invention relates to a method of retrieving electronic documents, and more particularly, to a method and a system of establishing electronic documents for storing, retrieving, categorizing and quickly linking via a network.

2. Description of the Related Art

With the technology advancement and environment transition, the carrier, processing method and technique of information is improved. The popularity of the Internet and the World Wide Web (WWW) has removed major obstacles in the dissemination of information. More and more people are using the Internet to obtain information. Obstacles that arise during the course of knowledge transmission and formatting are fundamentally problems of inefficiency and inaccuracy.

The variety and the quantity of network resources, however, is too various and numerous. To ease the retrieval of information for the user, information on the network needs to be organized in an efficient and meaningful way.

Keyword searches are still in a primitive state. A user is typically presented with a blank screen or prompt and asked to type individual keywords or a short phrase that are used to perform the search. While keyword searches may find some relevant material, a large number of irrelevant material is often generated, and the relevant material is missed or lost. In addition, the user is required to know the typical terms, phrases, alternate spellings and abbreviations associated with the information category being searched.

For an information resource in a particular field, data in the information resource may have correlations with each other. In order to help the user to obtain more related data, the host Internet retrieval technology generates hyperlinks for the retrieved data. These hyperlink paths are established by a data manager, who must manually insert a URL address for each piece of hyperlinked data. Consequently, most data managers can only establish links from new data to old data, not from old data to new data. The user thus cannot obtain the latest related data when reading the old data.

### SUMMARY OF THE INVENTION

1. Forward Linking

The present invention can automatically update news articles with follow-ups as they are posted. For example, when a reader browses an article entitled “July 27: Judge Orders MP3 Sharing Service Napster to Shut Down,” The present invention would automatically find a link to an article entitled “July 29: Appeals Court Grants Napster Reprieve.”

2. Keyword-less Linking

The present invention can automatically link related articles even when they have no keywords in common. For example, an article entitled “Is That Your Final Answer? Viewers Choose ‘Survivor’” would be closely related to “Reality TV: What the New Shows Say About Us.” Although the titles don't share the same keywords, the present invention can calculate the similarity and provide a link.

3. Web-based User Interface

The present invention is accessible from any popular Web browser (e.g. Microsoft Internet Explorer™), allowing users to take advantage of its features from any computer platform. This ease of accessibility means that reporters, columnists, and editors can instantly and conveniently exchange articles and updates.

4. Workflow Customization

The present invention's workflow management system is designed for flexibility and versatility, so users can customize the design for maximum efficiency and efficacy.

The object of the present invention is to provide a method and a system of establishing electronic documents for storing, retrieving and categorizing via a network to enable a data provider to upload and store an electronic document in a predetermined document format on the system. In this manner, the present invention improves the accuracy of data retrieval and provides extra information to assist in a search.

Another object of the present invention is to provide a method and a system of linking electronic documents together quickly to enable a user to immediately obtain retrieval results and all related data and corresponding hyperlinks.

To achieve these objectives, the method and the system of the present invention provides three different interfaces:

1. User End Interface

The present invention ensures that users are able to access the most useful subject matter by focusing on the four major factors of content searching: classifications, keywords, interrelationships, and time.

When a user chooses an article or other piece of information, the present invention automatically searches the content and compiles a list of articles that are most relevant to the subject being perused. In addition, the present invention also looks for synonyms and suggests keywords that are relevant to the content but not actually present within in the article. Users are thus able to effectively gather information even if their searching methods differ from the classification set by administrators.

In fact, the ability for all users to share from a knowledge base is fundamental to the present invention's business logic. It is by culling value from every article and every interrelationship that the present invention captures the true spirit of knowledge management.

2. Author End Interface

The present invention's author end software provides an intuitive windows-based interface for editors to upload new articles and content to servers. At the same time, they can automatically or manually select the article's keywords and relation to other documents. The present invention indexes and stores these relationships so that furniture follow-up articles will be quickly detected and linked.

3. Administrative End Interface

Administrators hold the highest authority in the present invention system, which allows them to manage uploading and caching as well as define synonyms and relationship rules.

As editors are uploading articles, administrators are able to update, amend, delete, and inquire about the content. Thus if an outdated article requires a critical update, the administrator can easily revise the old article, and the changes will be reflected in all related information.

Additionally, the present invention allows administrators to customize the weight of keywords during searches, as well as adjust the searching algorithms themselves.

Administrators can also define synonyms, a powerful relationship-finding feature that addresses a major shortcoming of traditional full-text searching.

Other objects, advantages, and novel features of the invention will become more apparent from the following detailed description when taken in conjunction with the accompanying drawings.

### BRIEF DESCRIPTION OF THE DRAWINGS

FIG. 1 is an environment schematic diagram of a system and method of the present invention applied to a news website.

FIG. 2 is structure diagram and simplified flowchart of the information retrieval system of the present invention.

FIG. 3 is a screen display of the uploaded document receiving means of the information retrieval system establishing an electronic document.

FIG. 4 is a screen display of category administration of the information retrieval system of the present invention.

FIG. 5 is a screen display of vocabulary administration of the information retrieval system of the present invention.

FIG. 6 is a screen display of file administration of the information retrieval system of the present invention.

FIG. 7 is a screen display of system administration of the information retrieval system of the present invention.

FIG. 8 is flowchart of the present invention method of retrieving and linking documents.

FIG. 9 shows a retrieve result at a category level of the present invention.

FIG. 10 shows a retrieve result at a keyword level of the present invention.

FIG. 11 is a flowchart of an algorithm of the present invention.

FIG. 12 is a flowchart for document format transformation of the present invention.

FIG. 13 is a screen display of an electronic news document of the present invention.

FIG. 14 is a schematic diagram and a flowchart of a cache of the present invention.

### DETAILED DESCRIPTION OF THE PREFERRED EMBODIMENT

In the following detailed description, numerous specific examples are set forth in order to provide a thorough understanding of the present invention. However, it will be understood by those skilled in the art that the present invention may be practiced without these specific examples. In other instances, well known methods, procedures, components, and circuits have not been described in detail so as not to obscure the present invention.

The present invention provides an information retrieval system for establishing electronic documents for storing, retrieving, categorizing and quickly linking together. The electronic documents in a preferred embodiment of the present invention are general electronic news reports published on a news website.

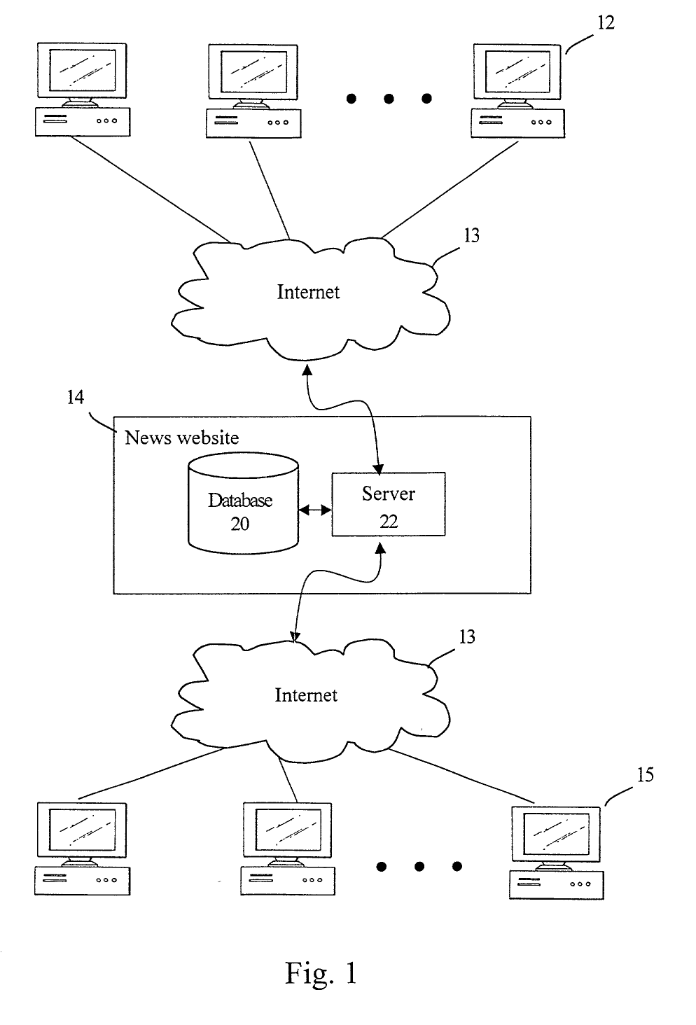

Please refer to FIG. 1. FIG. 1 is an environment schematic diagram of the system and method of the present invention, applied to a news website 14. The news website 14 contains a plurality of published electronic news documents. A user 12 connects to the news website 14 via a network 13, such as the Internet, to browse the published electronic news documents. An authorized data author 15 also connects to the news website 14 via the network 13 and edits a new electronic news document in an on-line electronic document establishing form in a root structure system provided by the news website 14.

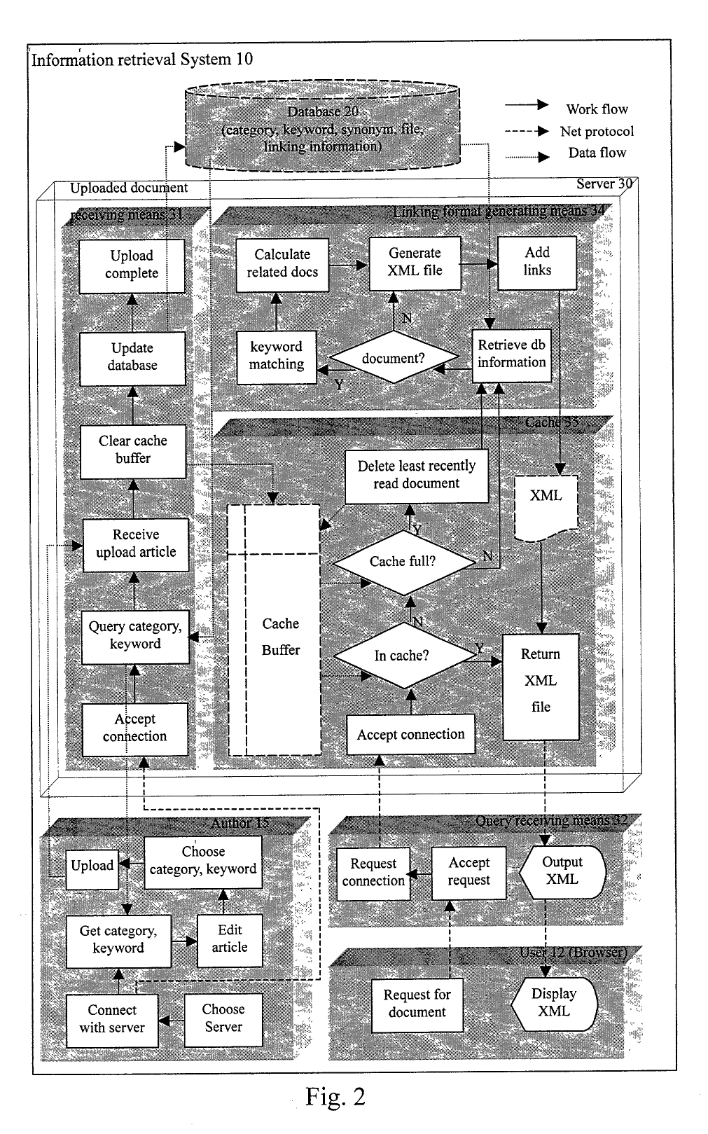

Please refer to FIG. 2. FIG. 2 is structure diagram and simplified flowchart of the information retrieval system of the present invention. The information retrieval system 10 comprises: a database 20 for storing associated data of all electronic documents and a server 30 connected to the network 13. The server 30 comprises: an uploaded document receiving means 31, an query receiving means 32, a selecting means 33, a linking format generating means 34 and a cache 35.

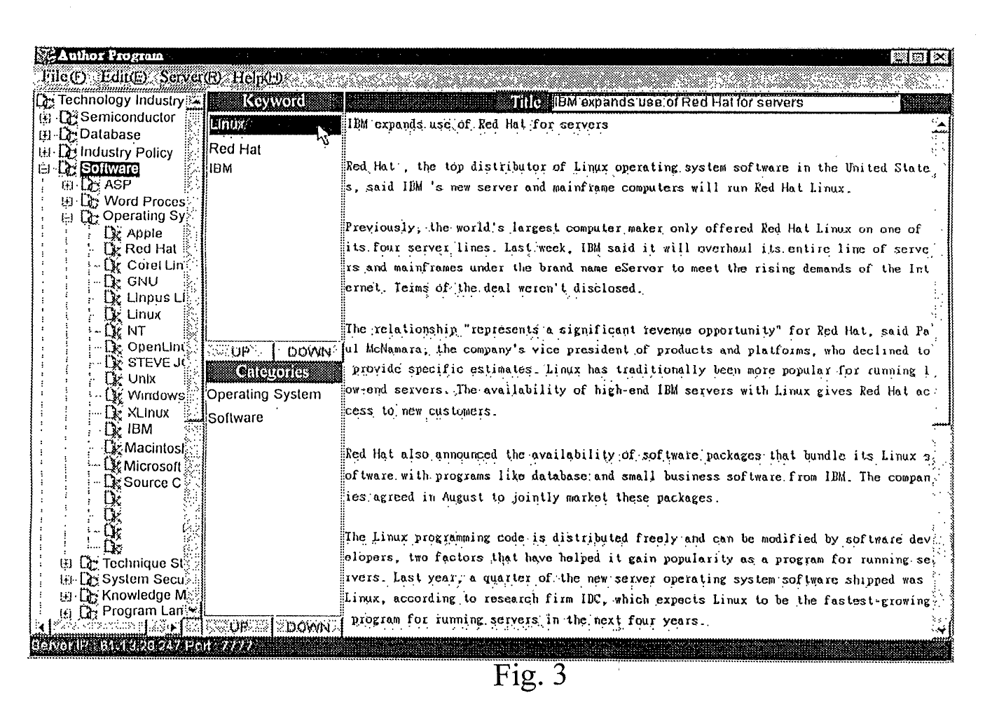

Please refer to FIG. 3. FIG. 3 is a screen display of the uploaded document receiving means of the information retrieval system establishing an electronic document. The uploaded document receiving means 31 is used for receiving an uploaded document in the on-line electronic document establishing form from the authorized data author 15 and storing the document in the database 20. The on-line electronic document establishing form includes a plurality of predetermined definition items: a title definition item, a body definition item, a keyword definition item, and a category definition item. As shown in FIG. 3, the authorized data author 15 establishes an electronic document with a title “IBM expands use of Red Hat for servers”, in addition to the title and the article body. The authorized data author 15 needs to define at least one category, such as: operating system, software, etc., and at least one keyword, such as: Linux, Red Hat, IBM, etc. according to the content of the article. Additionally, the selected sequencing order of each category and each keyword implies their relative importance. In order to simplify the process of document establishment and document management, an authorized manager of the news website 14 provides the definition items for keywords, and the definition items for categories for the authorized data author 15. Finally, when the electronic document is finished, the authorized data author 15 uploads the electronic document to the news website 14 via the Internet 13.

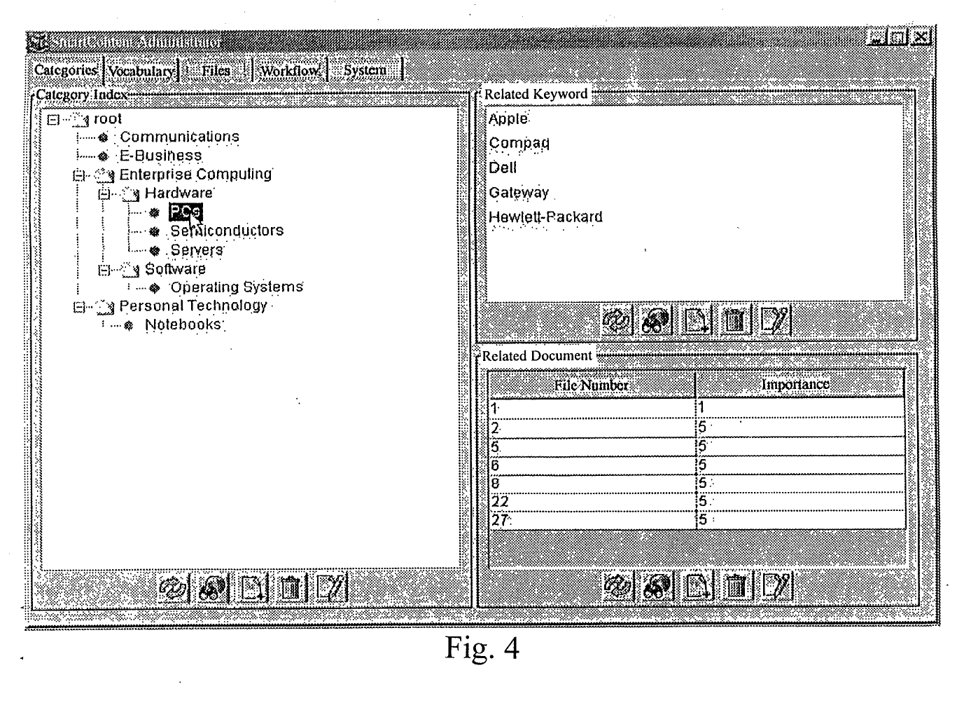

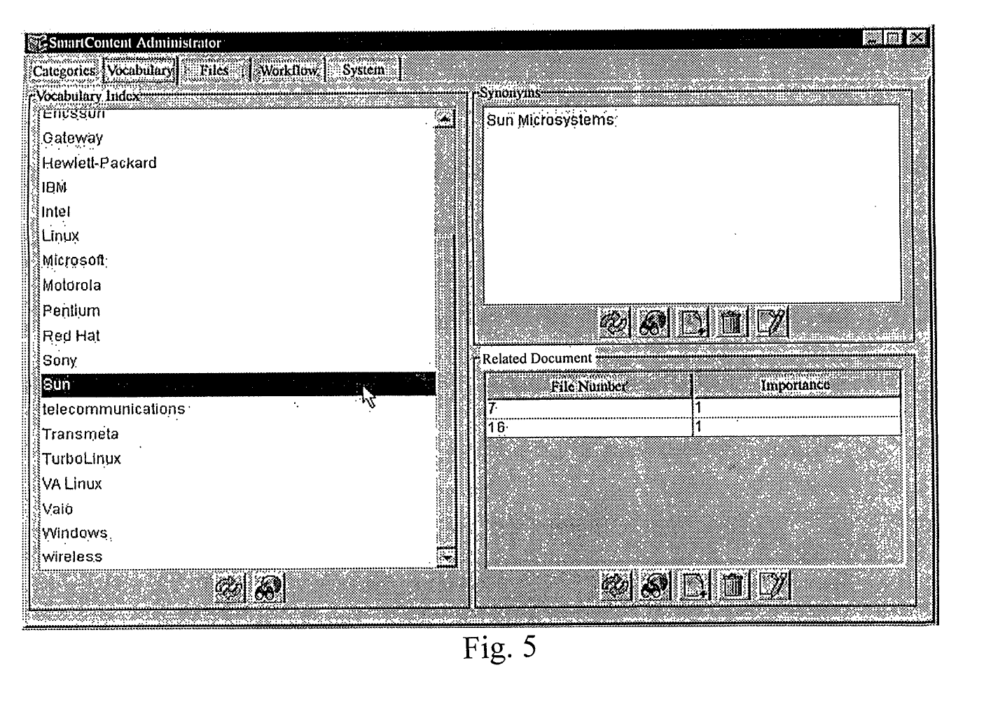

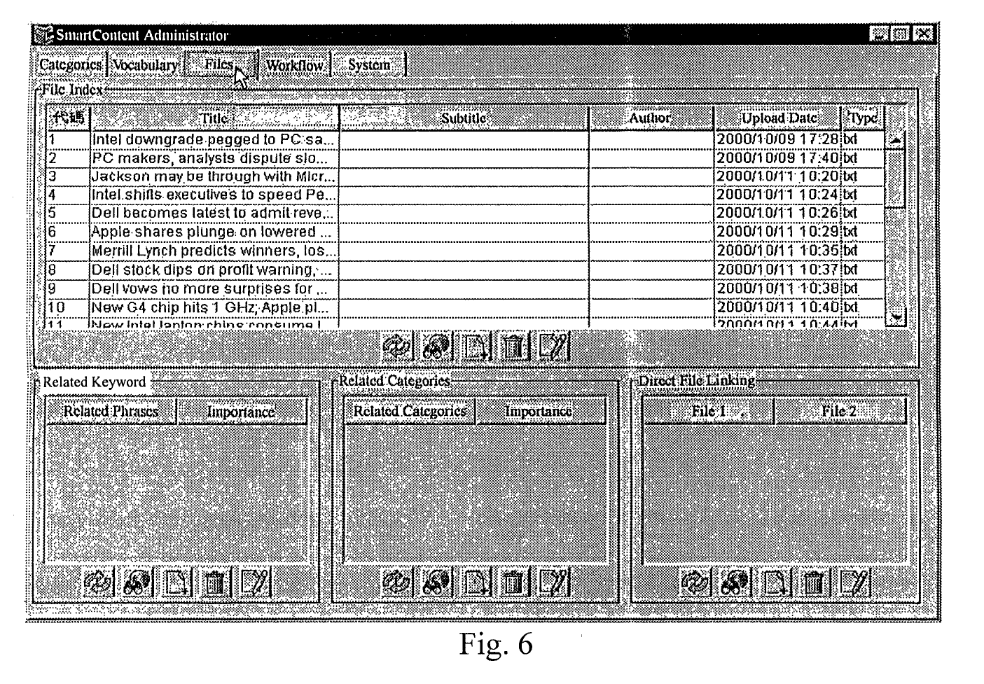

Please refer to FIG. 4 to FIG. 6. FIG. 4 is a screen display of category administration of the information retrieval system 10 of the present invention. FIG. 5 is a screen display of vocabulary administration of the information retrieval system 10 of the present invention. FIG. 6 is a screen display of file administration of the information retrieval system 10 of the present invention. The information retrieval system 10 of the present invention provides different administration interfaces according to the definition items to assist the system administrator with the individual storing of each electronic document in the database 20, and the linking of the electronic documents to each other.

As shown in FIG. 4, the information retrieval system 10 provides a category administration, which has a category index list, a related phrase list and a related article list. When any category item is selected, the related phrase list and the related article list show the related phrases and the related article lists. The searched related article is indicated by its title or its file number. Moreover, the system administrator can increase, remove or modify the content of the three lists. In order to simplify the usage of the administration interfaces for the system administrator, the system administrator may utilize a tree structure to administer the category index.

As shown in FIG. 5, the information retrieval system 10 provides category administration, which includes a vocabulary index list, a synonym list and a related article list. Since one object can be represented by many different phrases that have the same meaning, for more exhaustive retrieving and searching, each keyword vocabulary can be defined to represent a plurality of synonyms. Taking “Sun” as a keyword vocabulary example, “Sun” is defined as having the synonyms “Sun Microsystems”. Consequently, during the retrieval procedure, all articles that include “Sun” or “Sun Microsystems” will be selected. When any keyword vocabulary item is selected, the related phrase list and the related article list show the synonym list and the related article list. Similarly, the system administrator can increase, remove or modify the content of the three lists.

As shown in FIG. 6, the information retrieval system 10 provides file administration, which includes a file index list, a related phrase list and a related category list. The file index list includes a title, a number, an upload date, etc., for each uploaded document. When any file is selected, the related phrase list and the related article list show the synonym list and the related articles list. Similarly, the system administrator can increase, remove or modify the content of the three lists.

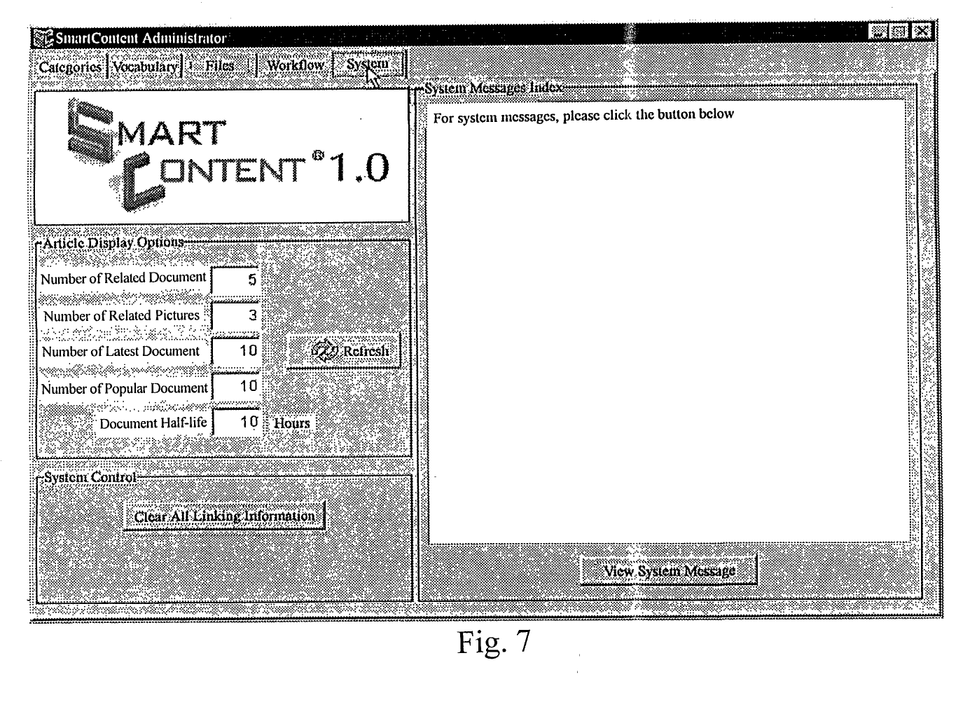

Please refer to FIG. 7. FIG. 7 is a screen display of system administration of the information retrieval system of the present invention. The system administration provides file administration, which includes an article display option list for the system administrator to set the number of related articles in retrieval result, and other system administration functions.

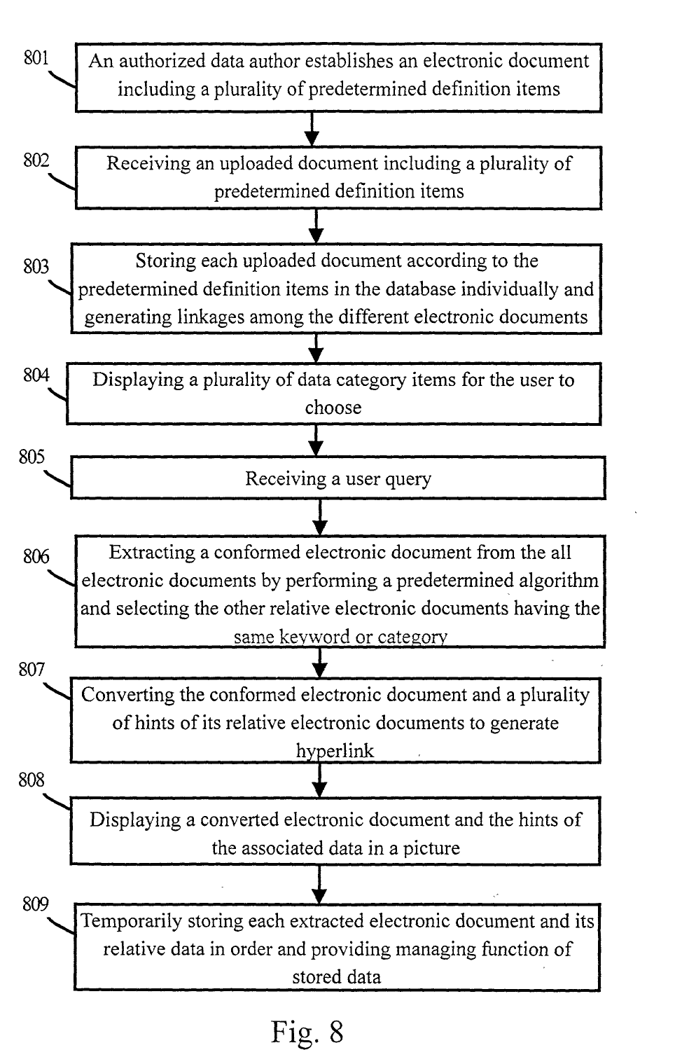

Please refer to FIG. 8. FIG. 8 is flowchart of the method of retrieving and linking the documents. In step 801, an authorized data author 15 establishes an electronic document via the network 13. The document comprises: the title definition item, the body definition item, the keyword definition item, and the category definition item. In step 802, the uploaded document receiving means 31 receives the uploaded document, including a plurality of definition items, and stores the document in the database 20. In step 803, the database 20 individually stores each electronic document according to every definition item and generates links between the different electronic documents. In step 804, a plurality of data category items are displayed from which a user may choose. In step 805, the query receiving means 32 receives a query from the user. In step 806, the selecting means 33 extracts a conforming document, as well as associated data from all the documents stored in the database 20, by executing a predetermined algorithm. In step 807, the linking format generating means 34 transforms the conforming document and associated data into a predetermined format to automatically generate a hyperlink for each predetermined definition item in the conforming document. In step 808, the information retrieval system 10 displays both the transformed conforming document and references from the associated data. In the step 809, a cache 35 is used to temporarily store each extracted electronic document and its associated data in order. Additionally, in step 804, the information retrieval system 10 further provides a full-text search function that presents a screen that enables the user to enter individual keywords. The information retrieval system 10 performs a progressive search and retrieve operation, using the various items established when the documents were created. The ordering of the retrieving levels is: the category level first, the keyword level second and the document level last. Therefore, regardless of the retrieval manner that the user utilizes to initiate the query, the information retrieval system 10 ascertains the proper level of the query, and then provides additional retrieval levels or retrieval results.

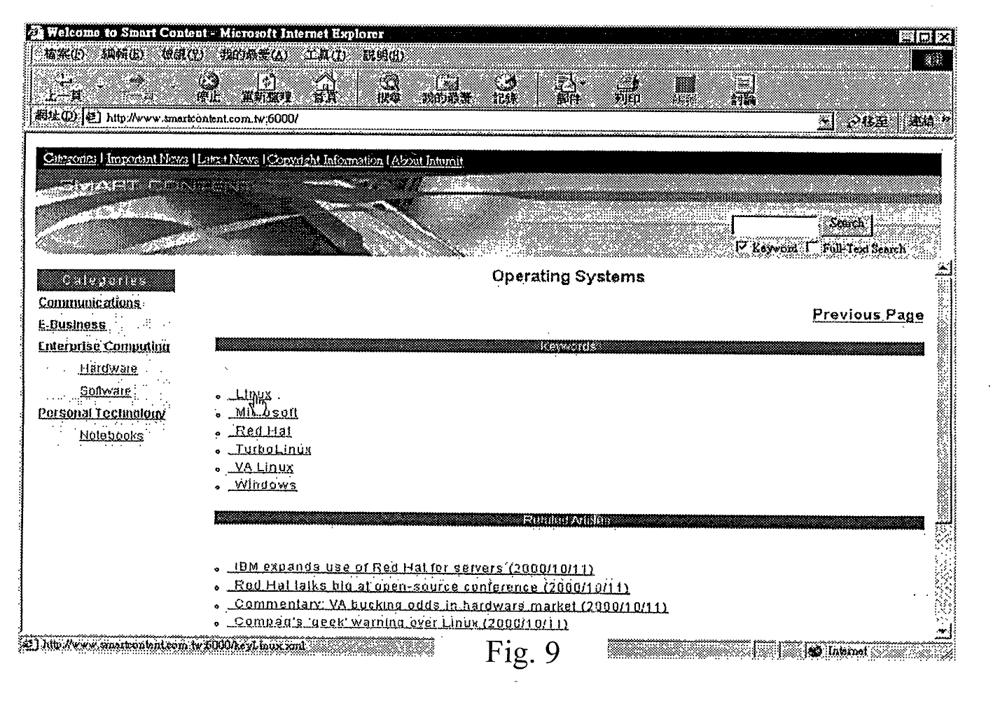

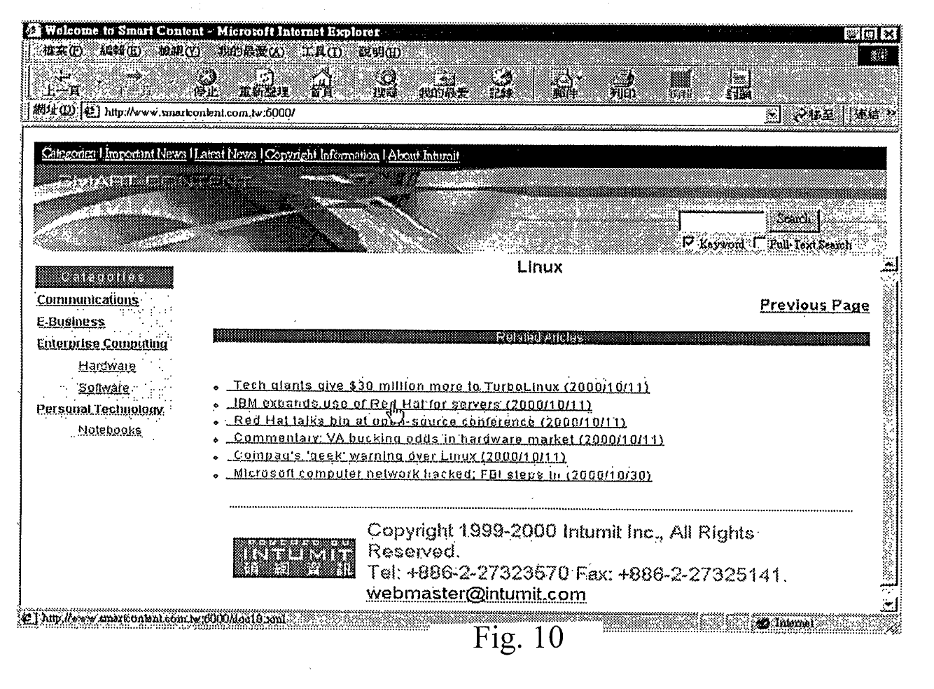

Please further refer to FIG. 9 and FIG. 10. FIG. 9 shows a retrieval result at the category level of the present invention. FIG. 10 shows a retrieval result at keyword level of the present invention. When the information retrieval system 10 receives a user query, the information retrieval system 10 ascertains the level of the query. As shown in FIG. 9, the user query is “operating system”, which belongs to the category level. The information retrieval system 10 displays the related keywords and the titles of the related articles that are defined as belonging to this “operating system” category during the category administration process. As shown in FIG. 10, when the user selects the related keyword “Linux”, the information retrieval system 10 displays the titles of the related articles that are defined as belonging to the keyword “Linux” during the vocabulary administration process.

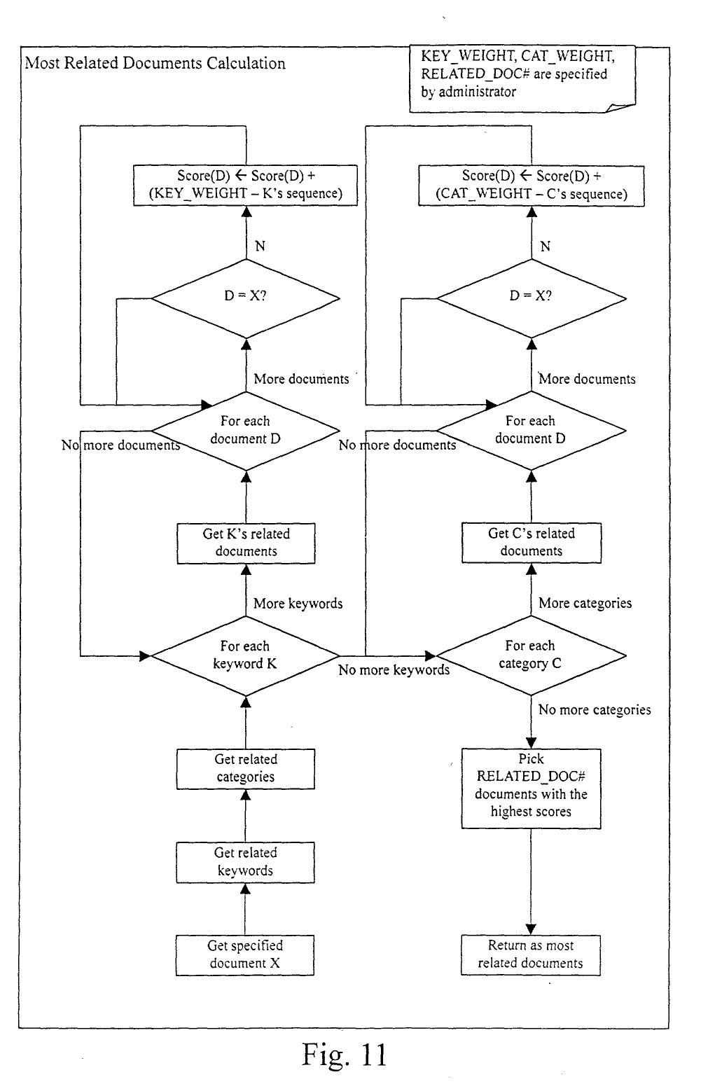

Please refer to FIG. 11. FIG. 11 is a flowchart of the predetermined algorithm of the present invention. When the retrieval level of the query reaches down to the document level, the selecting means 33 of the information retrieval system 10 extracts conforming documents and their associated data. The related electronic documents for each electronic document are extracted by executing the predetermined algorithm to calculate the relative relatedness of each electronic document according to the keywords and the categories. When the information retrieval system 10 finds a specific document X according to the user query, the categories and keywords of the specific document X are used. Next, documents D that are found that are related to the specific document X according to each keyword K (and its synonyms) and each category C. Each related document D, except the specified document X, is scored to extract from all related documents D. In the algorithm, a complementary weighting score of the keywords and the categories of each document can be modulated. Furthermore, the weighting score of the keywords and the categories of each document, and the number of related documents, are specified by the system administrator. The score calculation includes:

1. Scoring the defined sequence of keywords and categories of each document as a sequence score in the algorithm.

2. Subtracting the sequence score of the keywords and the categories from the weight score of the keywords and the categories of each related document.

3. Totaling the sequence score and the weight score of each related document.

Finally, the selecting means 33 selects a predetermined number of related documents having the highest scores.

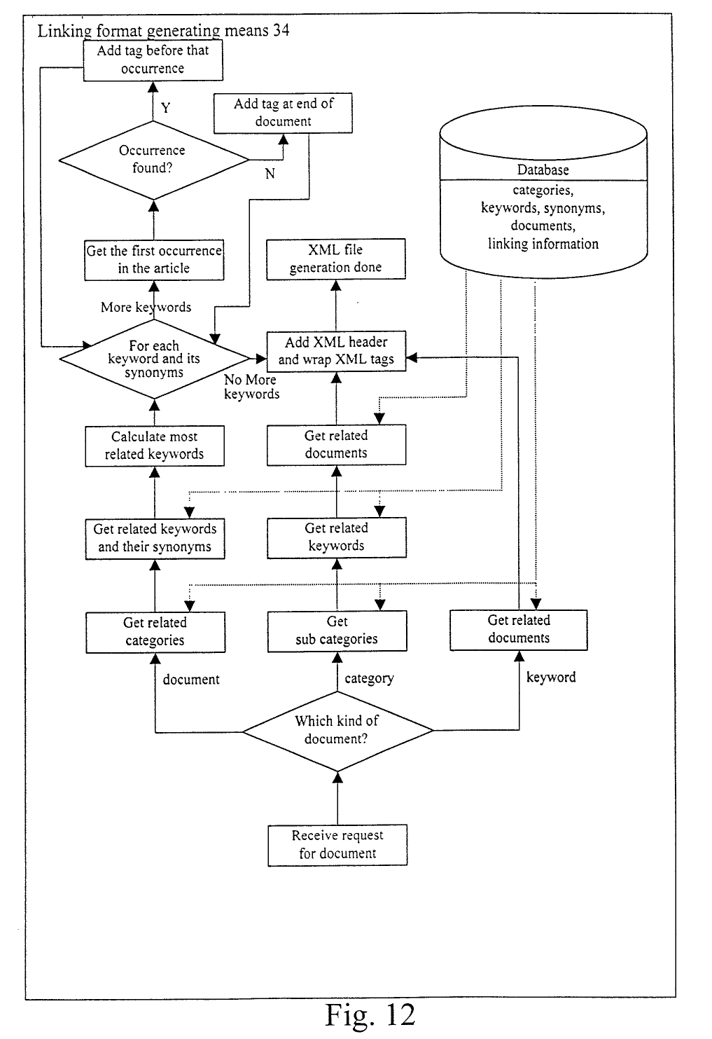

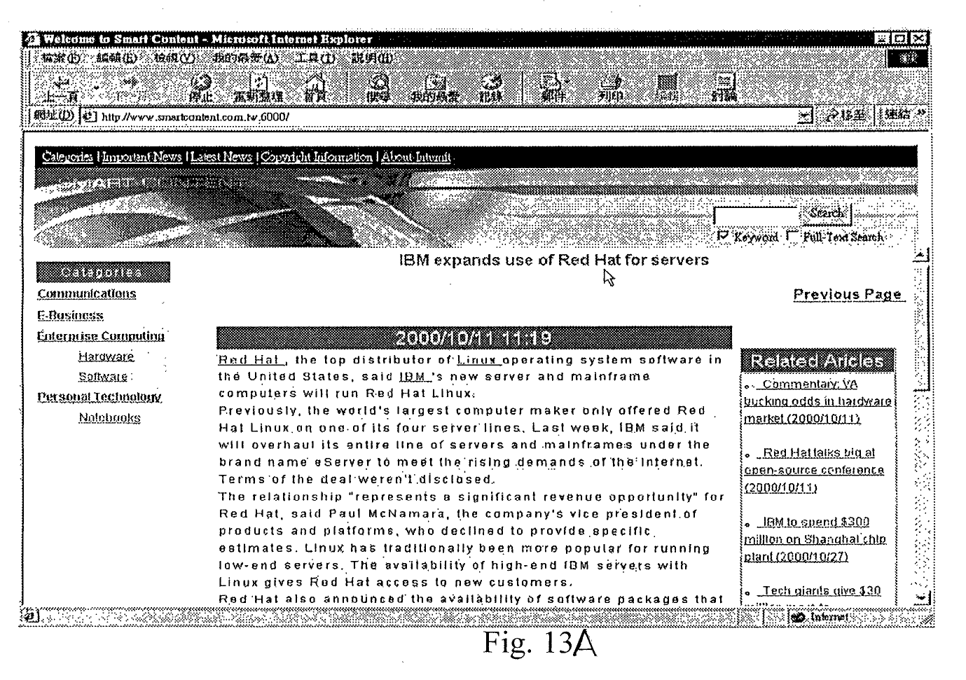

Please refer to FIG. 12. FIG. 12 is a flowchart of the document format transformation of the present invention. As above-mentioned, when the information retrieval system 10 receives a user query, the information retrieval system 10 ascertains the level of the query. Thereafter, the information retrieval system 10 obtains different retrieval results from the database 20 according to the different levels of the query. For different retrieval results, the linking format generating means 34 transforms the different retrieval results into a corresponding transforming format by utilizing Extensible Markup Language (XML) and Extensible Stylesheet Language (XSL). The linking format generating means 34 thus automatically generates hyperlinks for the different retrieval results, such as: title item, keyword items and category item of the conforming document and the references for the related documents. All different transforming formats are stored in the database 20.

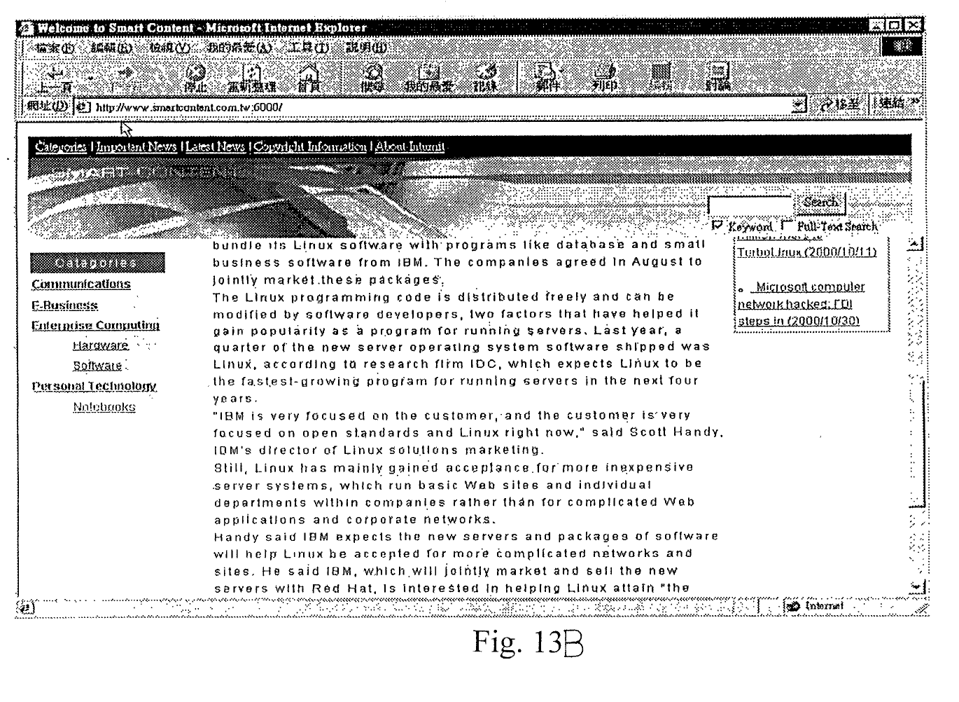

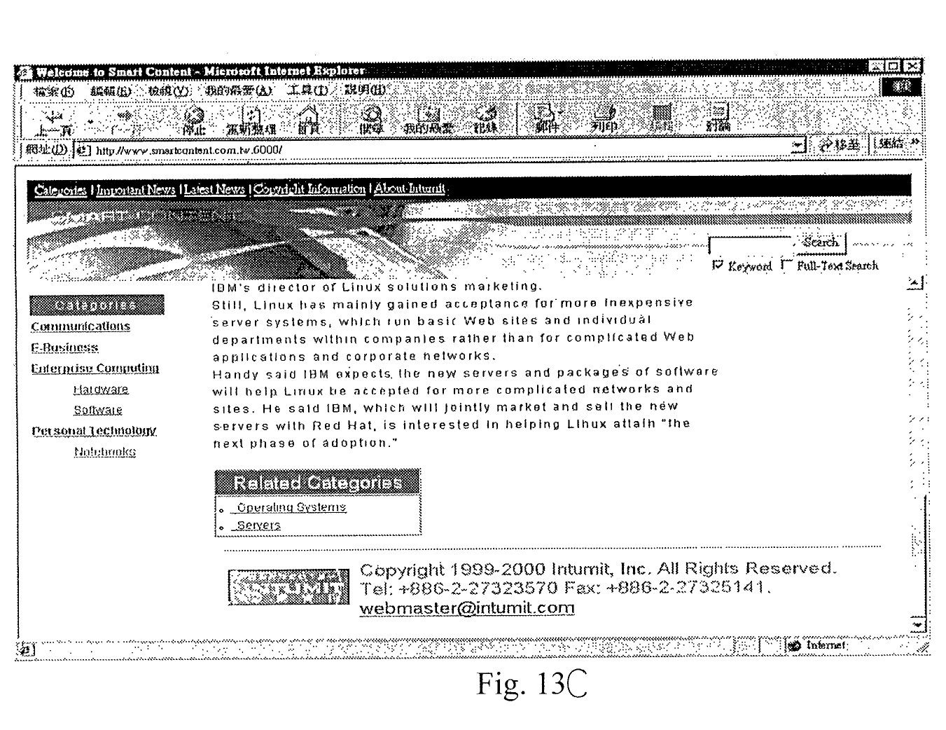

Please refer to FIGS. 13a-c. FIGS. 13a-c are screen displays of an electronic news document of the invention. After the information retrieval system 10 finds the conforming document and selects the related documents from the database 20, all searched data is transformed into the transforming format to generate links. The information retrieval system 10 can automatically link related articles even when they have no keywords in common. Although the titles don't share the same keywords, the information retrieval system 10 can calculate their similarity, that is, their relative degree of relatedness, and provide a link.

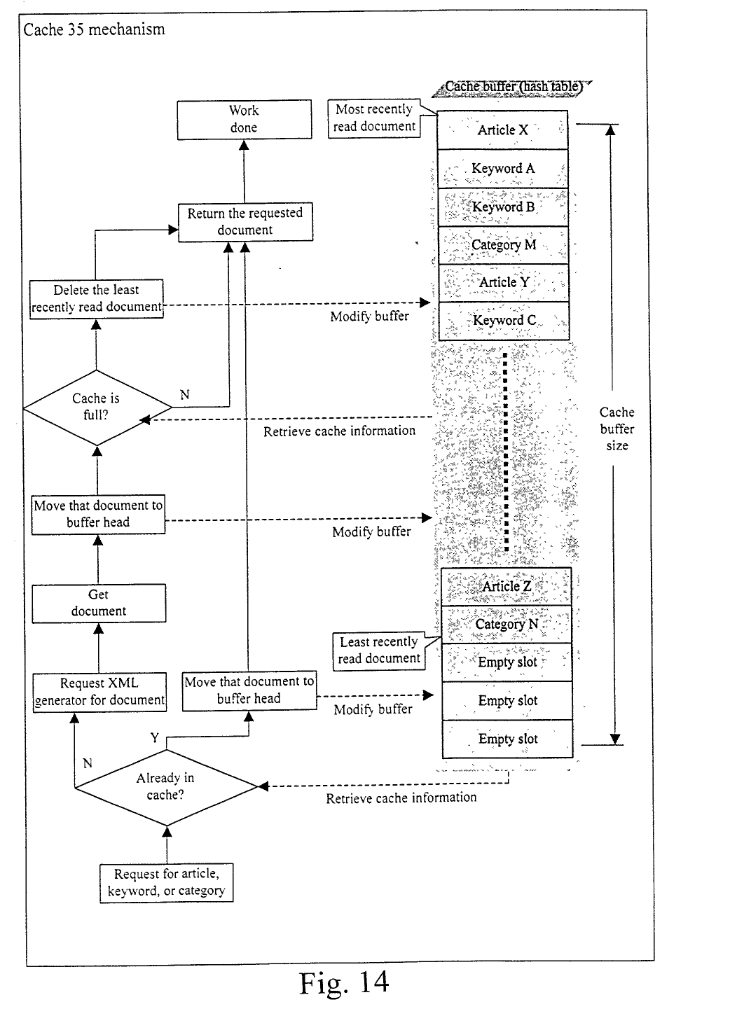

Please refer to FIG. 14. FIG. 14 is a schematic diagram and a flowchart of the cache of the present invention. The information retrieval system 10 further provides a managing function of the stored data in cache 35 for the system administrator. The system administrator is able to set a storing available limit for the electronic documents stored in the cache 35, such as stored time limit, or the number of read times. When each new electronic document is uploaded, all electronic documents and related data stored in the cache 35 are eliminated to avoid missing links to the new uploaded electronic document.

The present invention features several advantages that distinguish it from other knowledge management systems:

1. Support for Synonyms—Problems with homograph ambiguity and word segmentation have long beset Chinese full-text searches. Not only can XML account for variations in sentence structure, but detailed information about a phrase's meaning can also be stored. Thus when confronted with synonyms or acronyms, The present invention will instantly recognize its relevance to a search query.

2. Forward Linking—Until now, knowledge management software could only link to information written or compiled in the past; future updates required a separate search. By storing every article's interrelationships in a separate database, The present invention can instantly link preview articles to their follow-ups. For example, an article describing a court case would normally be linked only to events that led up to the case, but the present invention will search ahead and link to a later story that reports the outcome of the case.

Although the present invention has been explained in relation to its preferred embodiment, it is to be understood that many other possible modifications and variations can be made without departing from the spirit and scope of the invention as hereinafter claimed.

What is claimed is:

1. A method of establishing electronic documents for storing, retrieving, categorizing and quick linking to enable a user to browse the electronic documents and related information via a network, the method comprising:
establishing an electronic document via the network, the document comprising: a title definition item, a body definition item, a keyword definition item, and a category definition item;
individually storing each electronic document according to every definition item and generating links among the different electronic documents;
displaying a plurality of data category items from which the user is able to choose;
receiving a user query;
extracting a conforming electronic document by performing a predetermined algorithm to compare every definition item of each electronic document and selecting other related electronic documents having the same keyword or category; and
converting definition items of the conforming electronic document and a plurality of references from the related electronic documents into a predetermined format to generate hyperlinks for the definition items and the references.

2. The method of claim 1, further comprising the step of providing an on-line electronic document-establishing form in a root structure system, which enables an authorized data author to edit a new electronic document via the network.

3. The method of claim 1, further comprising the step of simultaneously displaying a converted electronic document and the references of the associated data.

4. The method of claim 1, further comprising the step of providing a managing function to an authorized administrator to control all electronic documents.

5. The method of claim 1, further comprising the step of temporarily storing each extracted electronic document and its related data in order and providing a managing function of stored data.

6. The method of claim 1, further comprising the step of establishing category definition items in a tree structure.

7. The method of claim 1, further comprising the step of automatically providing the keyword definition item and the category definition item for the authorized data author.

8. The method of claim 1, wherein the category definition item is used to define a domain classification of each new electronic document, and each electronic document can be referenced to a plurality of different category definition items.

9. The method of claim 1, wherein each new electronic document has at least one keyword which is defined according to the content of the electronic document.

10. The method of claim 1, wherein the related electronic documents of each electronic document are extracted by performing a predetermined algorithm to calculate the relative relatedness of each electronic document according to the keywords and the categories, and a complementary weighting of the keywords and the categories of the algorithm can be modulated.

11. The method of claim 1, wherein each keyword can be defined as identical to a plurality of synonyms.

12. The method of claim 1, wherein the predetermined format is programmed using Extensible Markup Language (XML) or Extensible Stylesheet Language (XSL).

13. The method of claim 13, wherein the content and the definition item of each electronic document are stored as Extensible Markup Language. (XML).

14. The method of claim 5, wherein when each new electronic document is generated, all temporarily stored electronic documents and related data are eliminated.

15. The method of claim 1, wherein the electronic document includes: text files, documents, pictures, photographs, drawings, voice file, film file and video stream.

16. A retrieval system for establishing electronic documents for storing, retrieving, categorizing and quick linking enabling a user to browse the electronic documents and related information via a network, the system comprising:
a database for storing associated data of all electronic documents;
a server connected to a network, the server comprising:
an uploaded document receiving means for receiving an uploaded document that includes a plurality of predetermined definition items, and individually storing the document according to the predetermined definition items in the database;
a query receiving means for receiving a query from a user;
a selecting means for extracting a conforming document and associated data from all the documents stored in the database by executing a predetermined algorithm to find a conforming document and other associated data; and
a linking format generating means for transforming the conforming document and associated data into a predetermined format to automatically generate hyperlinks for each predetermined definition item.

17. The information retrieval system of claim 16 further comprising a cache for storing a predetermined number of documents and associated data provisionally and managing all stored data.

18. The information retrieval system of claim 16, wherein the predetermined definition items includes a title definition item, a body definition item, a keyword definition item, and a category definition item.

19. The information retrieval system of claim 18, wherein the category definition item is used to define a domain classification of each new electronic document, and each electronic document can reference a plurality of different category definition items.

20. The information retrieval system of claim 16, wherein the information retrieval system builds category definition item in a tree structure.

21. The information retrieval system of claim 16, wherein the keyword definition item, and the category definition item are automatically generated by the information retrieval system.

22. The information retrieval system of claim 16, wherein each new uploaded document has at least one keyword which is defined according to the content of the document.

23. The information retrieval system of claim 16, wherein the related electronic documents of each electronic document are extracted from the database by executing a predetermined algorithm to calculate the relative relatedness of each electronic document according to the keywords and the categories.

24. The information retrieval system of claim 16, wherein the related electronic documents of each electronic document are extracted by executing a predetermined algorithm to calculate the relative relatedness of each electronic document according to the keywords and the categories, a complementary weighting of the keywords and the categories of the algorithm capable of being modulated.

25. The information retrieval system of claim 16, wherein each keyword can be defined as identical to a plurality of synonyms.

26. The information retrieval system of claim 16, wherein the predetermined format is programmed using Extensible Markup Language (XML) or Extensible Stylesheet Language (XSL).

27. The information retrieval system of claim 26, wherein the content and the definition items of each electronic document are stored in the database using Extensible Markup Language (XML).

28. The information retrieval system of claim 16, wherein when each new electronic document is generated, all temporarily stored electronic documents and related data are eliminated.

29. The information retrieval system of claim 16, wherein the electronic document includes: text files, documents, pictures, photographs, drawings, voice files, film files or video streams.
